(19) United States
(12) Patent Application Publication
(10) Pub. No.: US 2017/0046666 A1
(43) Pub. Date: Feb. 16, 2017

(54) SYSTEM AND METHOD FOR EVALUATING A CUSTOMER PRIOR TO A TRANSACTION

(71) Applicant: ELITE INFORMATION SERVICES, LLC, West Salem, OH (US)

(72) Inventors: John M. Covender, West Salem, OH (US); Anthony Wellendorf, Akron, OH (US)

(21) Appl. No.: 14/823,286

(22) Filed: Aug. 11, 2015

(51) Int. Cl. G06Q 20/10; G06F 17/30; G06Q 20/20

(52) U.S. Cl. CPC G06Q 20/10; G06Q 20/20; G06F 17/30424

(57) ABSTRACT

Payment pattern information of at least one first consumer is sent by a first computer device of a first user to a central computer, where it is stored. A searchable database is created including the payment pattern information of the at least one first consumer received from the first computer device. The searchable database is queried by a second computer device of a second user, wherein the query may include customized consumer profile criteria established by the second user. The query including the customized consumer profile criteria is compared to the payment pattern information of the at least one first consumer in the searchable database. One of only an approval and a disapproval is generated in response to the query, the one of only an approval and a disapproval based at least in part on an identity of the at least one first consumer and the customized consumer profile criteria.

### FIELD

The present invention relates to transactional sales risk mitigation and loss prevention, and in particular, to a system and method for evaluating a customer prior to entering into a commercial transaction.

### BACKGROUND

In the U.S., approximately $150 billion enters into the debt collections systems every year as Reported Debt. Of that sum, collections agencies only recover approximately $40 billion, which is about 25% recovery on delinquent Reported Debt. In addition, countless billions more are lost each year by creditors who never go after smaller, unpaid debts that are not entered into the debt collections systems, and are therefore not part of the Reported Debt amount.

In fact, no one knows the magnitude of the smaller, unpaid debts that are not entered into the debt collections systems. Delinquent Reported Debt is only a small part of the whole economic debt system. For example, it is estimated that each year consumers bounce checks valued at over $126 billion. Additionally, consumer charge backs to credit cards annually exceeds $100 billion. Both bounced checks and credit card charge backs increase the costs of doing business for goods and services providers. However, there is no single source system available to goods and services providers to monitor or prevent bounced checks or consumer charge backs. Thus, from the perspective of the goods and services providers, there is no single source solution system available to mitigate consumer risk.

Collections, bounced checks, and credit card charge backs aggregated over the years are all part of Accumulative Reported Debt, which exceeds $24 trillion in the United States. But the Accumulative Reported Debt represents only about 24% of the debt economy that uses conventional modern debt reporting tools. It is estimated that about $70 trillion in debt exists outside of conventional modern debt reporting tools listed as Unreported Debt. Unreported Debt includes any debt that is not subject to reporting using conventional modem debt reporting tools, and as such, is not captured within any formal debt industry database. Thus, for example, Unreported Debt may be accrued by new participants to the economy for whom no database entry exists, such as youths, the unbanked, individuals participating in transactions where it is too expensive to report to conventional modem debt reporting tools, and youths. Unreported Debt may also be accrued by “credit invisible” individuals or individuals for whom no credit information exists, such as undocumented or unregistered individuals, and those individuals that participate in a wholly cash, barter or underground economy. It is estimated that in approximately 75% of commercial transactions, there is no record of the consumers in the commercial transaction in any of the conventional modem debt reporting tools. Thus, even if a goods and services provider were to utilize all conventional modem debt reporting tools to research all consumers prior to entering into a commercial transaction therewith, approximately three quarters of the time the conventional modem debt reporting tools would return no useful information.

The aforementioned issues simply cannot be solved with conventional debt reporting tools. It is estimated that only about 4% of businesses report bad debt using conventional debt reporting tools, such as credit agencies or collection agencies. Generally, businesses that do report bad debt using conventional debt reporting tools include only large and medium sized businesses. However, there are over 22 million self-employed individuals in the United States, the number of which continue to increase, that do not report bad debt using conventional debt reporting tools. Moreover, there are over 5.7 million small businesses that do not report bad debt using conventional debt reporting tools, either due to the cost of reporting bad debt or due to the time and effort it requires to utilize conventional modem debt reporting tools.

The debt industry is also growing faster than ever. The Bureau of Labor Statistics anticipates that during 2015 and 2016, the debt collection industry will experience a 23% growth, a much faster rate than the average for most other industries. Much of the increased demand for conventional debt reporting services will come from smaller business organizations, such as real estate offices, landlord/tenant agencies or businesses, professional services providers such as doctors' and lawyers' offices, and the like. Additionally, increased demand for conventional debt reporting services will come from larger professional service providers, such as from hospitals, and from government agencies, including from the IRS.

Many types of industry verticals currently exist that include tracking organizations that act as a clearing house for payment history information. However, the industry verticals are limited to information available only within their own specific industry. None of these existing clearing houses are capable of communicating with other industries outside of that vertical. Information generated by one clearing house is not shared with other clearing houses, and none of the clearing houses is able to process information gathered by that clearing house efficiently to provide it to other industries or to providers of goods and services.

Accordingly, most businesses currently enter commercial transactions or deals with consumers without knowing if a consumer poses a non-payment risk to the company. From the perspective of a small business owner or of any business transacting with a participant in the Unreported Debt economy, one of the best ways to prevent and to solve issues with bad debt is to avoid situations where credit or goods and services are provided to individuals who have a history of non-payment. However, there are currently very few easily available and cost effective resources to help protect businesses from slow or non-paying customers before extending credit to or doing businesses with them. The current standard practice of waiting until some amount of payment is owed is too late. Collections efforts take a lot of time and energy and may only return a fraction of the debt owed. Standard credit checks are cost prohibitive, require approval from the customer, and are not always accurate or current.

It is therefore desirable to supply businesses with information that would allow the businesses to know whether a prospective customer is a high risk for payment failure based on prior activity. It is further desirable to assist the self-employed, small businesses, and any other business by providing a method to mitigate potential losses and to provide business with a relatively inexpensive, fast, and simple way to choose how and when to deal with potential lost revenue due to a customers poor payment history.

### SUMMARY

In concordance with the instant disclosure, a system and method for evaluating a customer prior to a transaction, that enables a business to know whether a prospective customer is a high risk for payment failure based on prior activity, that further enables a business to mitigate potential losses, and which also provides a business with a relatively inexpensive, fast, and simple way to choose how and when to deal with lost revenue due to a customers' poor payment history, has surprisingly been discovered.

A computer method of pre-qualifying and warning business owners of customer risk is provided. The method involves a system having a central computer in communication with a first computer device of a first user. The central computer is in communication with the first computer device of the first user by the Internet. The central computer includes a server having a processor and a memory. In one step, the first computer device of the first user sends to the central computer payment pattern information of at least one first consumer. The payment pattern information is in the form of one of a text message, an email, a web application, and a database transfer application. In another step, the central computer stores the payment pattern information received from the first computer device. A searchable database is created including the payment pattern information of the at least one first consumer received from the first computer device. In another step, a query is received by the central computer from a second computer device of a second user. The query includes customized consumer profile criteria established by the second user. The central computer next compares the query including the customized consumer profile criteria to the payment pattern information of the at least one first consumer in the searchable database. The central computer generates either an approval or a disapproval in response to the query. The one of only an approval and a disapproval is based at least in part on an identity of the at least one first consumer and the customized consumer profile criteria. Finally, the one of only an approval and a disapproval is transmitted to the second computer device of the second user through the Internet.

In one embodiment, the central computer tracks each query of payment pattern information of the at least one first consumer. A periodic payment is disbursed to the first user based at least in part on a frequency of queries to the payment pattern information of the at least one first consumer sent by the first computer device of the first user to the central computer.

In another embodiment, the payment pattern information of the at least one consumer includes identification information of the at least one consumer. In another embodiment, the payment pattern information includes purchasing habits of the at least one consumer.

In another embodiment, the searchable database may be made available as a central database to third parties for one or more of resale, as part of a direct access portal, as part of a point of sale device, and to be bundled and distributed.

### BRIEF DESCRIPTION OF THE DRAWINGS

The above, as well as other advantages of the present disclosure will become readily apparent to those skilled in the art from the following detailed description of the preferred embodiments when considered in light of the accompanying drawings, in which:

FIG. 1 illustrates an overview of a network or Internet architecture for implementing a system and method for evaluating a customer prior to entering into a commercial transaction according to one embodiment of the disclosure;

FIG. 2 illustrates an overview of components that comprise one embodiment of a system and method for evaluating a customer prior to entering into a commercial transaction;

FIG. 3 illustrates an overview of a set of databases that comprise one embodiment of a system and method for evaluating a customer prior to entering into a commercial transaction;

FIG. 4 illustrates an exemplary data upload process flow chart according to one embodiment of a system and method for evaluating a customer prior to entering into a commercial transaction;

FIG. 5 illustrates an exemplary database manipulation process flow chart according to one embodiment of a system and method for evaluating a customer prior to entering into a commercial transaction;

FIG. 6 illustrates an exemplary questionnaire for generating a desired customer profile according to one embodiment of the disclosure;

FIG. 7 illustrates a flow chart showing the possible steps performed by the central processing computer according to one embodiment of the system and method for evaluating a customer prior to entering into a commercial transaction;

FIG. 8 is a summary diagram illustrating a system and method for evaluating a customer prior to entering into a commercial transaction according to one embodiment of the disclosure; and

FIG. 9 illustrates an exemplary overview of a point of sale device according to one embodiment of the system and method for evaluating a customer prior to entering into a commercial transaction;

### DETAILED DESCRIPTION

The following detailed description and appended drawings describe and illustrate various exemplary embodiments of the disclosure. The description and drawings serve to enable one skilled in the art to make and use the disclosure, and are not intended to limit the scope of the disclosure in any manner. In respect of the methods disclosed, the steps presented are exemplary in nature, and thus, the order of the steps is not necessary or critical, unless otherwise disclosed.

Applicants have previously described an Information Service System and Method in U.S. patent application Ser. No. 13/683,757, filed on Nov. 21, 2012 and claiming priority from U.S. Provisional Pat. Appl. Ser. No. 61/563,425, filed on Nov. 23, 2011, the contents of both of which are hereby incorporated herein by reference in their entirety.

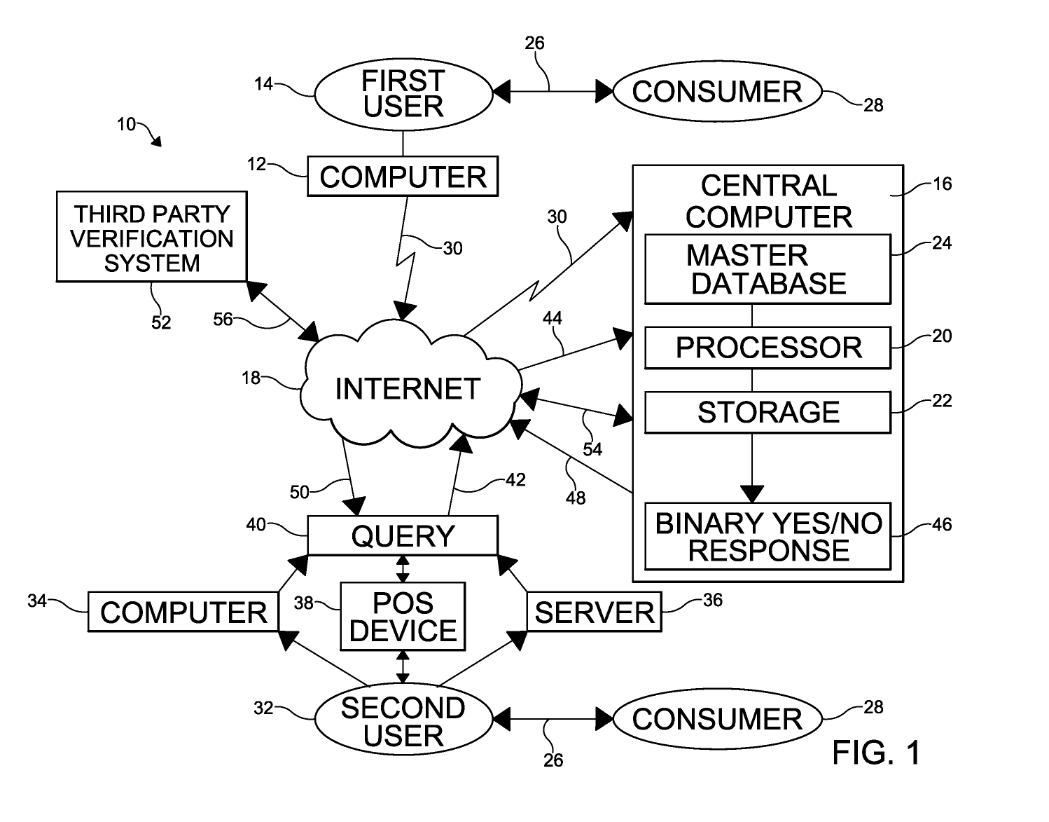

FIG. 1 provides an overview of a network or Internet architecture 10 for implementing various features of an embodiment of a system and method for evaluating a consumer prior to entering into a commercial transaction. As used herein, the term “consumer” is understood as including any of an individual, business entity, government, non-profit, medical, and professional association customer interested in entering into a transaction for the exchange of goods and/or services. It should be appreciated that the consumer can include other types of customers other than those expressly listed hereinabove.

A first computer device 12 operated by a first user 14 communicates with a central computer 16 via a network and/or the Internet 18. The central computer 16 may include a processor 20, a storage or memory 22, and a master database 24, described in more detail hereinbelow, and may further include additional computational devices, including, but not limited to, further servers, routers, switches and other hardware as is known in the art. As used herein, the term “memory” may include a non-transitory and tangible computer-readable storage medium, on which databases and processor-executable software code may be embodied.

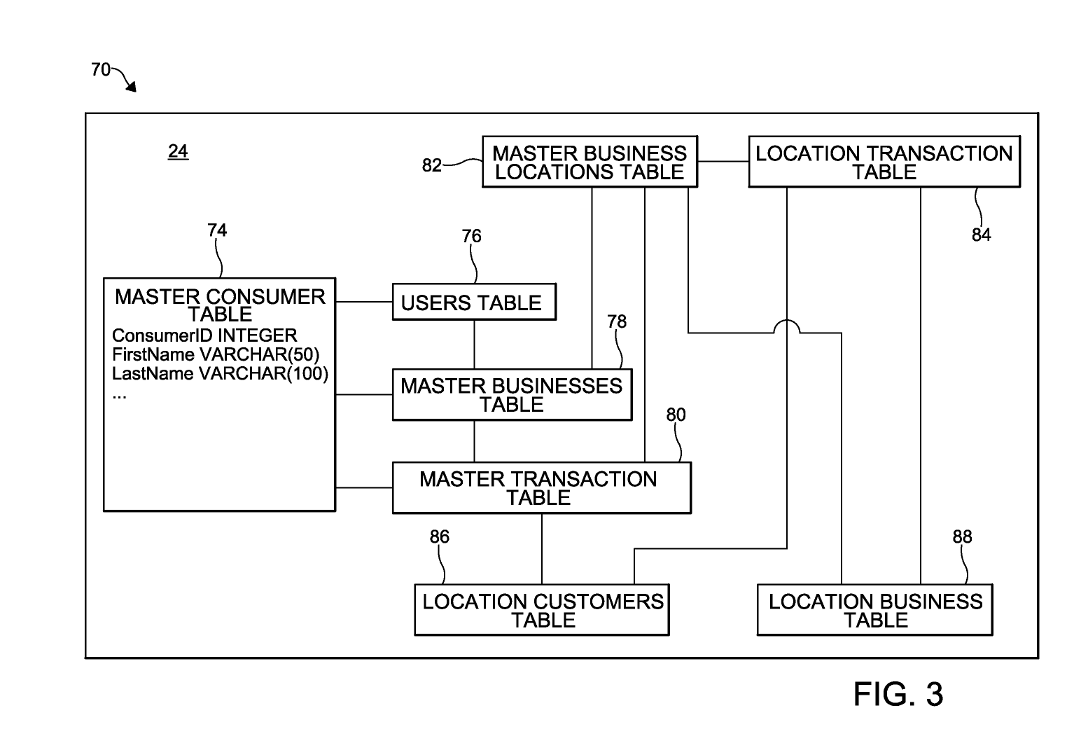

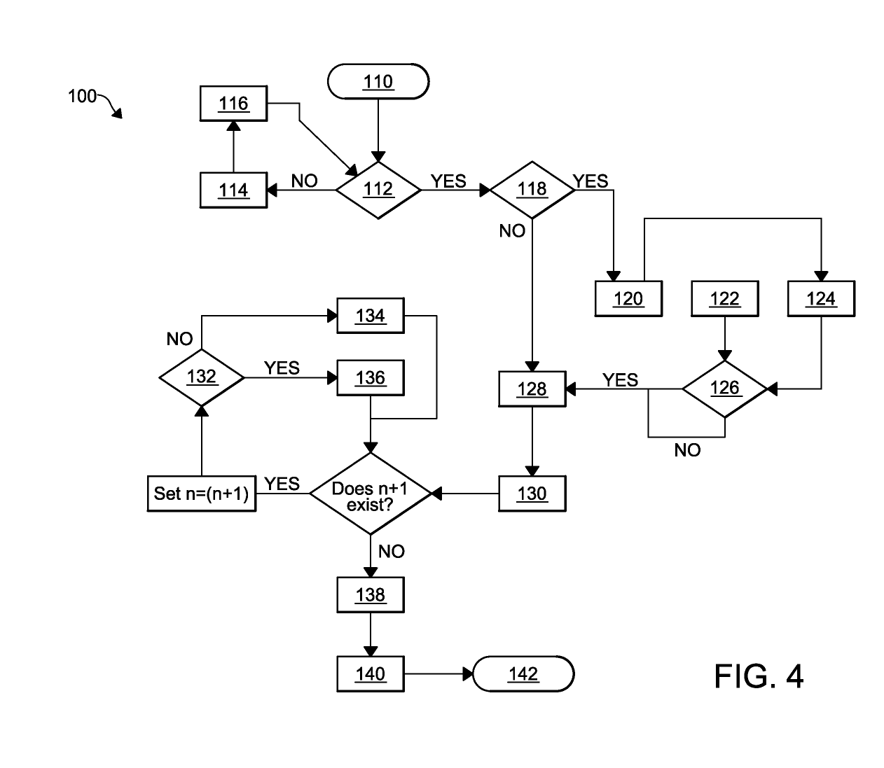

In one embodiment, the first user 14 is a vendor who enters into commercial transactions 26, such as transactions for goods and/or services, with at least one consumer 28, in exchange for payment thereof. According to one embodiment of the disclosure, certain of the at least one consumers 28 are good customers, while others of the at least one consumers 28 may experience difficulty or failure to pay for goods and/or services. It is understood that the at least one consumer 28 may participate in the Reported Economy, the Unreported Economy, or both. The first user 14 of the first computer device 12 submits to the central computer 16 payment pattern information 30 of the at least one consumer 28 compiled as a result of any commercial transactions 26 that occur between the first user 14 and the at least one consumer 28. The payment pattern information 30 sent by the first user 14 may include identification information of the at least one consumer 28, and further may include information about payment or non-payment made by the at least one consumer 28, credit card holds applied by the at least one consumer 28, or any other information that may be payment pattern information 30 of the at least one consumer 28. The payment pattern information 30 may be in the form of one of a text message, an email, a web application, a database transfer application, or any other usable form, and is uploaded to the master database 24, as discussed in further detail hereinbelow with reference to FIGS. 3 and 4.

It is understood that the first user 14 need not be an individual, and instead could be a business or corporate concern having access to payment pattern information 30 for a significant number of the at least one consumers 28 as a result of a plurality of commercial transactions 26 between the first user 14 and the at least one consumer 28.

According to one embodiment of the disclosure, a second user 32 contemplates entering into one or more additional commercial transactions 26 with the at least one consumer 28. The second user 32 may be concerned that the at least one consumer 28 may be a high risk for payment failure, or otherwise may wish to discover whether the at least one consumer 28 is a preferred customer. Using a second computer 34, a central server 36, or a point of sale device 38, the second user 32 submits a query 40 to the central computer 16, including the master database 24, via a network and/or the Internet 18. Submission of the query 40 is indicated by reference 42 in FIG. 1, and receipt of the query 40 by the central computer 16 is indicated by reference 44 in FIG. 1.

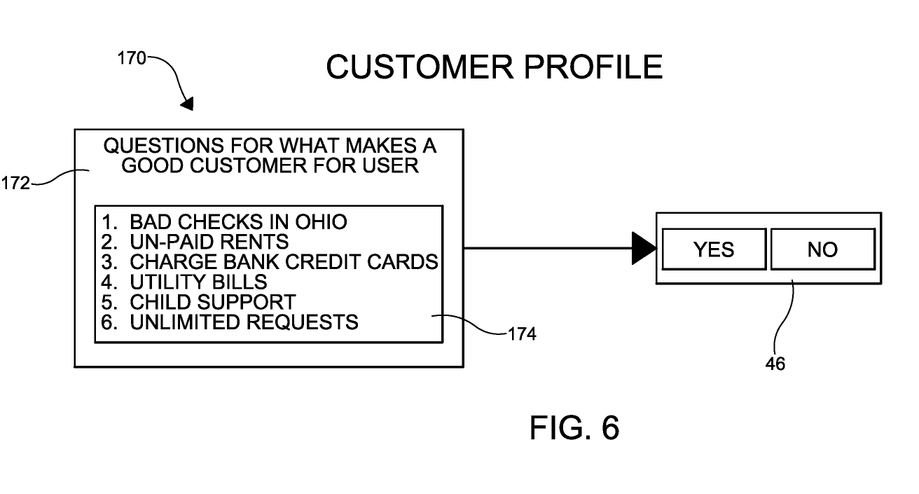

The query 40 includes information sufficient to identify the at least one consumer 28, and additionally may include customized profile information, discussed in further detail hereinbelow with reference to FIG. 6, that serves both to identify the at least one consumer 28 and to establish a set of criteria against which to evaluate the payment pattern information 30 of the at least one consumer 28 contained in the master database 24 in response to the query 40.

Upon submission of the query 40, including any customized profile information, the central computer 16 evaluates the query 40 against the master database 24. The central computer 16 thereafter generates a binary response 46 that comprises only one of an approval and a disapproval for the commercial transaction 26, or for the at least one consumer 28 that is the subject of the query 40. In essence, the central computer 16, including the master database 24, generates only one of a “yes” and a “no” in response to the query 40. The only one of a “yes” and a “no” response 46 to the query 40 may be transmitted via a computer network such as the Internet 18. Transmission of the response 46 by the central computer 16 is indicated by reference 48 in FIG. 1, and receipt of the response 46 by the second user 32 is indicated by reference 50 in FIG. 1.

In one embodiment, the central computer 16 comprises the processor 20, the storage or memory 22, and the master database 24, and is configured to receive submission of the query 40, and to evaluate the query 40 against the master database 24 to generate the binary response 46 that comprises the only one of an approval and a disapproval for the commercial transaction 26, or for the at least one consumer 28 that is the subject of the query 40.

In another embodiment, the central computer 16 consists essentially of the processor 20, the storage or memory 22, and the master database 24, and is configured to receive submission of the query 40, and to evaluate the query 40 against the master database 24 to generate the binary response 46 that comprises the only one of an approval and a disapproval for the commercial transaction 26, or for the at least one consumer 28 that is the subject of the query 40.

By generating only the binary response 46, the central computer 16 does not share any of the payment pattern information 30 with the second user 32, thereby protecting the privacy of the at least one consumer 28. Additionally, since any query 40 only results in one of an approval and a disapproval response 46, the default response 46 can be an approval. For example, the default response 46 can be an approval in the situation where a query 40 is made about an at least one consumer 28 for whom no payment pattern information 30 exists in the master database 24, in which case new payment pattern information 30 is generated for the previously unknown at least one consumer 28 and is stored in the master database 24, as discussed in more detail hereinbelow.

It should be understood that, because any query 40 only results in one of an approval and a disapproval response 46, the central computer 16 and the master database 24 is not operating as a credit reporting service.

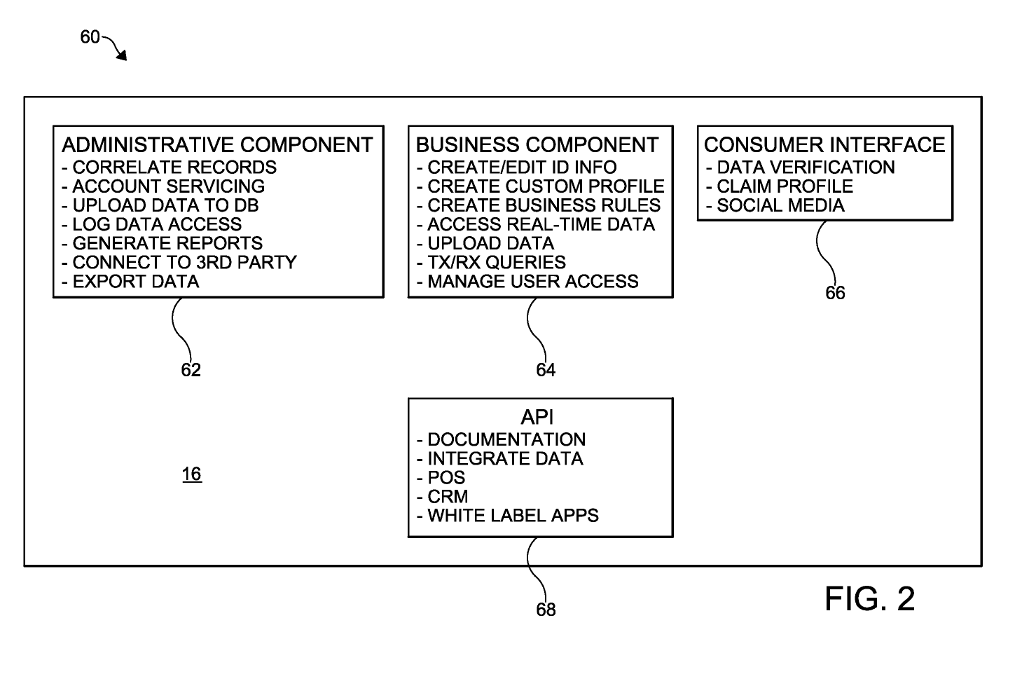

FIG. 2 illustrates an overview of components that comprise an embodiment of the central computer 16 of the present disclosure. It is understood that the various embodiments of the disclosure may include only some or all of the illustrated components. In one embodiment, the system 60 includes an Administrative component 62, a Business component 64, a Consumer Interface 66, and an Application Programing Interface (API) 68.

As illustrated in FIG. 2, the Administrative component 62 includes all aspects of the disclosure required to enable interaction with accounts and data created and maintained in the system. As non-limiting examples, the Administrative component 62 allows the system 60 or an administrative user (not shown) to correlate related records, service various accounts, upload data to one or more databases, log and track data access, generate reports, connect to third party resources, export data, or the like. The Administrative component 62 is therefore established mainly to manage accounts and data.

The Business component 64 is established to allow the various account holders to interface with data and with the account managed by the account holder. As non-limiting examples, the Business component 64 may allow the account holder to create and edit identification information, including business or transaction location information, create customized profile information or business rules against which entries in the database are compared as described in farther detail below, access and view real time data based on business identification information, upload data to one or more databases as described in further detail below, transmit and receive queries submitted to one or more databases, manage users of the business account or data, or the like. The Business component 64 is therefore directed to all aspects of account servicing and management. In one embodiment, the Business component 64 includes a first functionality accessible by Business Account Managers, and a second functionality accessible by Business Account Users. As a non-limiting example, the first functionality accessible by Business Account Managers may include the ability to create, edit and update various preferences to enable the Business Account Manger to use the system in performing business making tasks. As a further non-limiting example, the first functionality accessible by Business Account Managers may also include the ability to control access permission of various Business Account Users within designated accounts, and may include the ability to evaluate metrics and reports generated by the system to determine the effectiveness of the system for the business.

The Consumer Interface 66 allows for consumers to interact with the data in a public manner. As a non-limiting example, the Consumer Interface 66 may be accessible to individual consumers via a network and/or the Internet, or through any other publicly accessible interface. The Consumer Interface 66 allows for individual consumers to verify and validate any data contained within any database. As non-limiting examples, the Consumer Interface 66 may allow individual consumers to claim and merge profiles, verify records, flag records as unverified or incorrect, and the like. The Consumer Interface 66 may also interface with known social media to allow consumers to be integrated and connected to one or more databases, and further may allow for data to be verified.

The Application Programing Interface (API) 68 allows for expansion and interconnection between one or more of the databases and any external systems owned or operated by third parties including but not limited to customers, vendors, suppliers, and partners. As a non-limiting example, the API 68 may be constructed to allow for integration of defined data in one or more of a Point of Sale (POS) system, a Customer Relationship Management (CRM) system, or an Enterprise Resource Planning (ERP) system.

The system 10 of FIG. 1 relies on a series of interconnected databases to create a master database 24, illustrated in FIG. 3. The interconnected databases 70 may be discrete and cross-referenced, or may be stacked and integrated into a master database 24, as shown in FIG. 3. The master database 24 includes a further series of tables and records comprised of a plurality of databases, including a plurality of tables and records, as illustrated in FIG. 3.

As non-limiting examples, the master database 24 may include a consumers table 74, a user's table 76, a business table 78, a transaction table 80, a business location table 82, a transaction location table 84, customer location table 86, a user location table 88, and the like. Each of the tables 24, 74, 76, 78, 80, 82, 84, 86, and 88 are capable of storing information related to commercial transactions, businesses, consumers, users, and further are capable of storing payment pattern information generated during commercial transactions between goods and services providers and consumers. It is understood that some or all of the data included in any one of the tables 24, 74, 76, 78, 80, 82, 84, 86, and 88 may also be included in any other ones of the tables 24, 74, 76, 78, 80, 82, 84, 86, and 88. The master database 24 may be cataloged and cross-referenced using conventional or application specific tools. Additionally, the master database 24, as well as all of the other tables 74, 76, 78, 80, 82, 84, 86, and 88, are constructed and maintained to allow for additional information to be added and appended to each of the tables 24, 74, 76, 78, 80, 82, 84, 86, and 88 as additional data is added to the system 10 and to the interconnected databases 70.

Data to be stored within any of the databases 24, 74, 76, 78, 80, 82, 84, 86, and 88 is uploaded by the first user 14 or by the second user 32, as described above with reference to FIG. 1. An exemplary data upload process flow system 100 is shown in FIG. 4. It is understood that different process flow for file uploads may be utilized without departing from the disclosure. At step 110, a data file is uploaded. The data file may be one of a text message, an email, a web application, and a database transfer application. At step 112, the data file type is evaluated to determine if the data file type is supported. If the data file type is not supported, a display error message is returned at step 114, the required fields necessary for proper data submission are displayed at step 116, and the data is potentially resubmitted. If the data file type is supported at step 112, then the data file is evaluated at step 118 to determine if the data file contains an identifiable header row. If the data file does contain an identifiable header row, or if the algorithm determines that the data file contains an identifiable header row, then the system displays all columns and a predetermined number of rows at step 120 for review. In one embodiment, the system 100 determines if the data file includes fields corresponding to any fields in any of the databases or tables at step 126. As non-limiting examples, the system 100 may evaluate the data file to determine if any fields match the master consumers table 74 at step 122, or may evaluate the data file to determine if any fields match the master business table 78 at step 124. In one embodiment, the system 100 matches the data file header rows with data fields of one or more data bases at step 128, and then begins an iterative evaluation of each of the identified data fields at step 130.

During an exemplary iterative process, shown in FIG. 4, each column including a header row is evaluated and compared to one or more databases at step 132 to determine if the header row matches a data entry variable contained in the one or more databases evaluated. If no variable match is determined at step 132, a new variable is created by the system 100 at step 134 and the data is incorporated into one or more databases. If a variable match is determined in step 132, the uploaded data is added to the one or more databases at step 136, and the uploaded data is cross-referenced and propagated to any of the one or more databases that tracks the variable matched by the system 100. The system 100 iterates the data incorporation until all data uploaded is incorporated and a completion message is displayed at step 138. Thereafter, the data may be sorted at step 140 for additional or relevant data to create additional databases, for example, the location databases. Thereafter, the uploading process is completed at step 142.

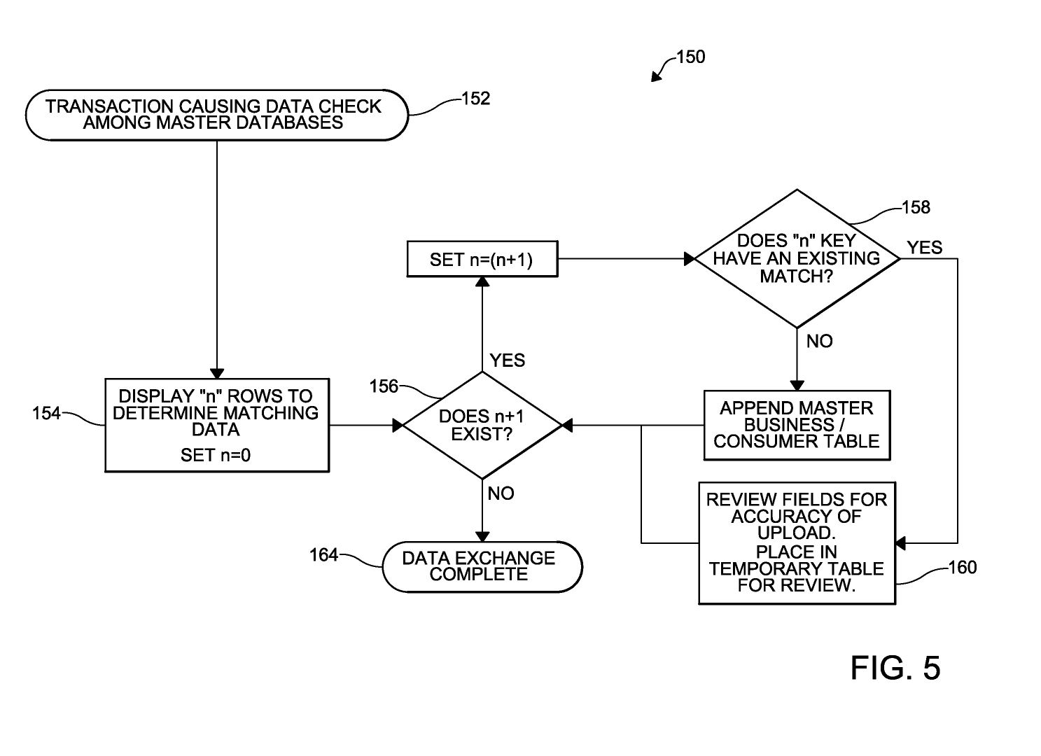

FIG. 5 shows an exemplary process 150 for evaluating, cross-referencing and propagating the submitted data at step 130 of FIG. 4. It is understood that the process 150 of FIG. 5 may be utilized in any instance that data is uploaded to the system 100, including when any new transaction 152 occurs that causes a data exchange or check between one or more of the databases 24, 74, 76, 78, 80, 82, 84, 86, and 88. It is understood that the new transaction 152 may be a singular transaction, or may represent a plurality of transactions that are being submitted for incorporation into one or more of the databases or tables 24, 74, 76, 78, 80, 82, 84, 86, and 88. The submitted data uploaded due to the transaction 152 is displayed at step 154, and an iterative evaluation process begins at step 156.

During the exemplary iterative process shown in FIG. 5, each set of submitted data is evaluated at step 158 to determine if one or more of the databases or tables 24, 74, 76, 78, 80, 82, 84, 86, and 88 includes matching data. If a data match does occur, then the matched set of submitted data is reviewed to ensure accuracy at step 160 and is held for review. If no data match occurs at step 158, then the submitted data is manipulated to an appropriate format at step 162 and the data is uploaded to one or more of the databases or tables 24, 74, 76, 78, 80, 82, 84, 86, and 88, as desired. The iterative evaluation terminates at step 164 after all the submitted data has been evaluated.

As noted above with reference to FIG. 1, a query submitted by a second user 32 may include information sufficient to identify at least one consumer 28, and additionally may include customized profile information. FIG. 6 discloses a sample format for entering a customized consumer profile 170. The customized consumer profile may be entered by the second user 32 at the POS device 38, the second computer 34, or the server 36 of FIG. 1. In one embodiment, the customized consumer profile 170 provides a questionnaire 172 to a second user for determining those aspects 174 of a consumer that make for a good customer. As non-limiting examples, aspects 174 that may be utilized include a lack of bad checks, unpaid or late rents, credit card charge backs, unpaid utility bills, unpaid child support, and the like, as shown in FIG. 6.

In one embodiment of the disclosure, the second user is able to identify those aspects 174 as part of a customer profile 170 included as part of the query 40 (FIG. 1). In another embodiment, the second user creates a pre-defined customer profile 170 that is automatically transmitted with the query 40. The customer profile 170 is utilized by the central computer 16 when the query 40 including appropriate identification information is compared to the payment pattern information of the one or more of the consumers in the master database 24. For example, if the consumer 28 is identified within the master database 24 as a result of the query 40, the customer profile 170 may be used to establish disqualification or qualification aspects that, if true, would result in a disapproval response 46.

With continued reference to FIG. 1, it should be appreciated that the query submitted by the second user 32 may sometimes, at least initially, not have enough information to identify the at least one consumer 28. For example, there may be more than one “John Smith” of record in the central computer 16, in which case a query for the consumer 28 having the same name may result in multiple hits. In such cases, the query may undergo either an internal verification or an external verification, prior to further processing by the central computer 16. The internal verification process is conducted at the central computer 16, in which the information from the consumer 28 is further analyzed to determine which, if any, of the records in the central computer 16 are related to the consumer 28. The further analysis may include cross-reference other information pertaining to the consumer 28 with information in the master database 24. The external verification process is conducted by a third party verification system 52, which can receive and send information to the central computer 16 through the Internet 18 as indicated by reference numbers 54 and 56 in FIG. 1, pertaining to the identity of the consumer 28. As with the internal verification process, further analysis and investigation of the information from the consumer 28 is conducted at the third party verification system 52, in order to ascertain the identity of the consumer 28. Upon return of this information to the central computer 16, the central computer 16 may then proceed with the generation of the approval of disapproval response relative to the customer profile, as described herein. It should also be understood that the second user 32 may select prior to submitting the query whether internal verification or external verification is desired, and should take place relative to the query.

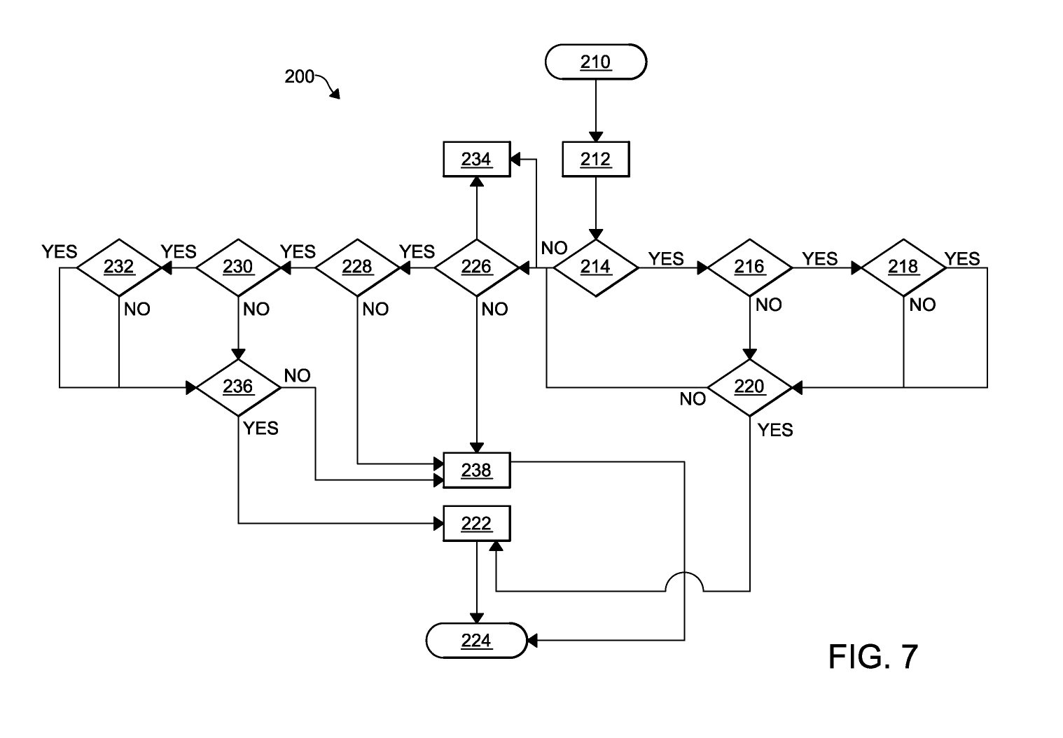

An exemplary flow chart 200 of the possible steps performed by the central processing computer 16 is shown in FIG. 7. In step 210, the central processing computer 16 receives a query regarding one or more consumers 28. In step 212, the central processing computer determines if the transaction being queried is business or consumer related in order to identify which of the one or more databases or tables against which to compare the query. In one embodiment, at step 214, the query is processed along one of two paths, depending on whether information about the consumer 28 exists in one or more of the databases or tables 24, 74, 76, 78, 80, 82, 84, 86, and 88. If the consumer 28 exists in one or more of the databases or tables, the system determines whether the consumer 28 is verified at step 216, and if so, whether the consumer 28 is trusted at step 218. The system then evaluates the consumer 28 against the customer profile 170 at step 220 to determine if the consumer 28 meets established qualification or disqualification aspects for the query. If the consumer 28 meets the established qualification aspects, a “yes” response is displayed in step 222, and the sequence terminates at step 224. If the consumer 28 fails to meet the established qualification aspects or meets any established disqualification aspects, or if the consumer 28 does not exist within one or more of the databases or tables, the query is processed along a second path where the system applies one or more predetermined criteria to the inquiry. As non-limiting examples, the system may determine whether the inquiring party uses a full data integration at step 226, whether the consumer 28 is listed in the master database at step 228, whether the consumer 28 is verified at step 230, whether the consumer is trusted at step 232, and the like. The system may further apply database manipulation at step 234 to process the query against one or more of the databases or tables 24, 74, 76, 78, 80, 82, 84, 86, and 88. Based on determinations made with respect to steps 226, 228, 230, 232, and the like, the system evaluates the consumer 28 against the customer profile 170 at step 236 to determine if the consumer 28 meets established qualification or disqualification aspects for the query. If the evaluation at step 236 determines that the consumer 28 does not meet established qualification aspects or meets any disqualification aspects, the system 200 displays a “no” response at step 238, after which the sequence terminates at step 224. It is understood that any negative result with respect to steps 226, 228, 230, 232 and the like may also result in the system 200 displaying a “no” response and terminating in step 224.

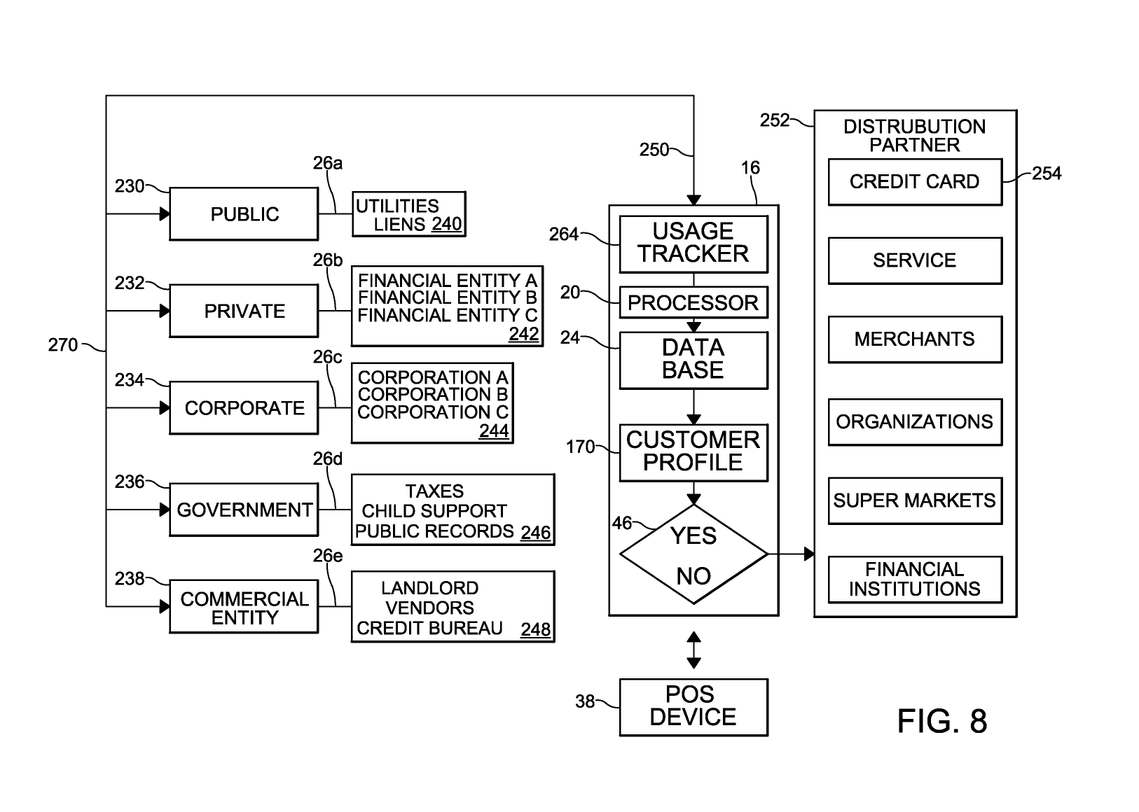

An embodiment of the system and method of the present disclosure may be summarized as illustrated in FIG. 8. As noted above with reference to FIG. 1, the first user 14 need not be an individual, and instead could be a business or corporate account having access to payment pattern information 26 for a significant number of consumers 28 operating in the Unreported Debt economy. In one embodiment, payment pattern information 26 is provided by one or more of public entities 230, private financial entities 22, corporate entities 234, government entities 236, and other commercial entities 238.

As a first non-limiting example, the public entities 230 may include publicly owned utilities or lien-holder registration entities, indicated at reference 240 of FIG. 8. Utilities typically amass significant data regarding consumers paying recurring bills over months, years, and even decades. However, late payments or non-payments of utility bills typically result in liens against property rather than in collections actions against persons, and so are not typically reported to credit reporting or collections agencies. Thus, a significant portion of payment pattern information 26a available from public entities 232 is representative of the Unreported Debt economy.

As a second non-limiting example, the private financial entities 232 may include for-profit or not-for-profit foundations, mortgage servicing entities, and financial service providers, including financial information services and on-line or electronic banking providers, indicated at reference 242 in FIG. 8. Foundations may generate significant data regarding gifts, pledges, and participation levels, correlated to individual consumers. Mortgage servicing entities and financial service providers similarly amass significant data regarding payment pattern information 26b potentially spanning years or even decades. While some of the private entities 232 may report total debt or an eventual non-payment within the Reported Debt economy, the private entities do not report payment pattern information 26b to the Reported Debt economy, and is therefore not available to other commercial goods and/or services providers. Thus, the present disclosure contemplates the private financial entities 232 having an opportunity to send payment pattern information 26b associated with the Unreported Debt economy to the central computer 16.

As a third non-limiting example, corporate entities 234 may include retail goods and/or services providers, particularly such as big-box stores, department stores, national franchisees, and the like, indicated at reference 244 in FIG. 8. Most such corporate entities 234 maintain customer lists or rewards programs from which to gather data for marketing purposes. However, the corporate entities 234 also amass significant data regarding late or non-payment, cash payment or credit payments, as well as number and frequency of returns, credit card holds, and the like. Such payment pattern information 26c is not reported to credit or collection entities, and is therefore unavailable to other commercial goods and/or services providers.

As a fourth non-limiting example, government entities 236 such as court collections, taxing authorities, or other public records repositories, indicated at reference 246 in FIG. 8, maintain significant data regarding payment pattern information 26d specifically relevant to payment or non-payment of taxes over long periods of time, including years or even decades. Similarly, court records may include payment pattern information 26d including, but not limited to, payment of judgments, child support, alimony, or the like, again over long periods of time. Failure to pay taxes or court-ordered monies may result in liens or warrants, only some of which are reported to conventional credit and collections entities. Accordingly, some of the data is within the Unreported debt economy and is not available to other commercial goods and/or services providers.

As a fifth non-limiting example, other commercial entities 238 may have access to significant payment pattern information 26e that is part of the Unreported Economy. Such payment pattern information 26e may be from any potential provider of goods and/or services, such as landlords, vendors, and the like, indicated at reference 248 in FIG. 8.

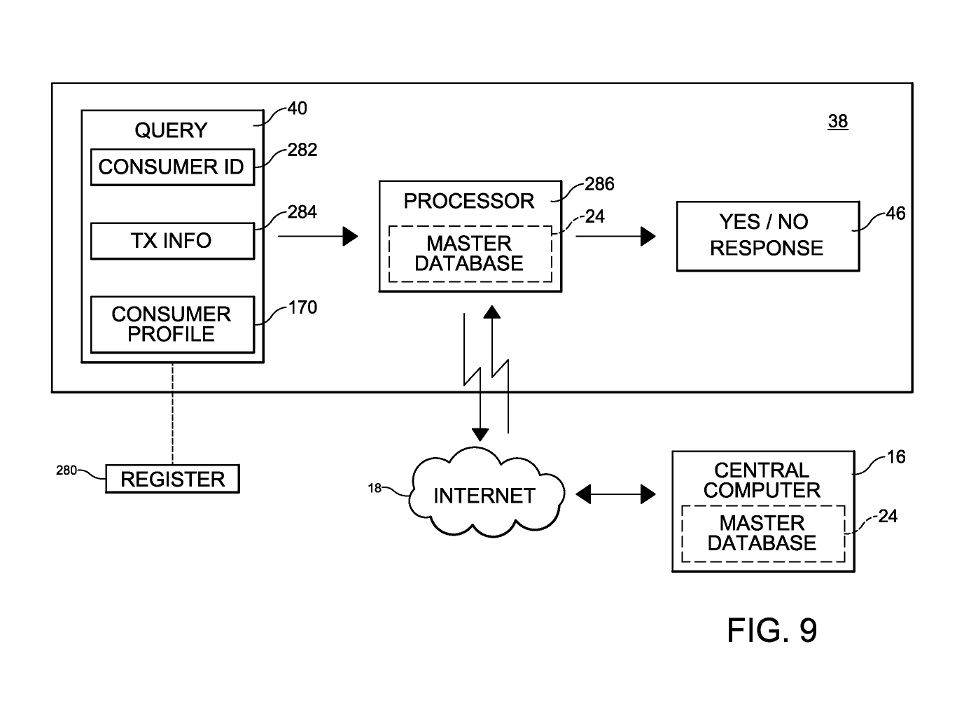

As shown in FIGS. 1 and 9, the payment pattern information 26a-26e is sent to and is collected by the central processing computer 16, indicated by reference 250 in FIG. 8, and is further aggregated in a master database 24, including one or more searchable databases (not shown). Importantly, any user 14, including one or more of the public entities 230, the private financial entities 232, the corporate entities 234, the government entities 236, and the other commercial entities 238, may also act as a second user 32 and submit query the master database 24, as discussed above with reference to FIG. 1. In practice, a second user 32 submits a query 40 to the master database 24. The query 40 may be generated on a second computer 34 or on a server 36, and may be transmitted via network and/or the Internet 18. The query 40 includes information sufficient to identify one or more of the consumers 28, and further includes customized consumer profile information 170, as discussed above with reference to FIG. 6, to establish a set of criteria against which to compare the payment pattern information 26 of the one or more of the consumers 28 in the master database 24 to the query 40. After comparing the payment pattern information 26 of one or more of the consumers 28 to the customized consumer profile information 170, the central computer 16 generates a response 46 that comprises one of only an approval and a disapproval, for the transaction being queried. In essence, the central computer 16, including the master database 24, generates only one of a yes and a no in response to the query 40. The only one of a yes and a no response to the query 40 may be transmitted via network and/or the Internet 18. By generating only a binary response, the central computer does not share any of the detailed payment pattern information 26 with the second user 32, thereby protecting the privacy of the one or more of the consumers 28. Additionally, because any query 40 only results in an approval or a disapproval 46, a default response can be either an approval or a disapproval as desired, as in the situation where a query is made about a consumer for whom no payment pattern information 26 exists in the master database 40, in which case new payment pattern information 26 is generated for a new consumer 28.

The master database 24 may be made available to one or more third party distribution partners 252. In one embodiment, the one or more distribution partners 252 are invited to submit queries to the master database 24 to receive a binary response 46 thereto based on a customized consumer profile 170 submitted by the one or more third party distribution partners 252, as described in detail herein above. In this way, the one or more distribution partners 252 may be able to obtain customer payment pattern information using information available in both the Reported Debt economy, through conventional debt reporting services, and in the Unreported Debt economy using the present system and method. Importantly, the customized consumer profile 170 may be limited to cause the master database 24 to compare payment pattern information 26 for a particular consumer 28 within a discrete segment of the economy, either by limiting the query 40 using Standard Industry Classification (SIC) codes or using any other suitable industry descriptor. Thus, as a non-limiting example, a credit card company may limit all queries 40 to return only payment pattern information 26 of a particular consumer 28 that relates in any way to credit card payment pattern information.

It should be understood that the system 10 may also be provided as a white- or private-labeled product, for example, relevant to a particular business or industry segment.

In another embodiment, the master database 24 may be bundled for distribution and use within one or more industry verticals, again divided by SIC code or by any other suitable industry descriptor. As a non-limiting example, the master database 24 may be customized and bundled for use in a credit card vertical, a banking vertical, a real estate vertical, or the like.

In another embodiment shown in FIG. 9, the master database 24 may be loaded onto a point of sale device 38 that is updated continuously or from time-to-time via a network and/or the Internet 18. The point of sale device 38 may be directly attached to point of sale register 280, or may comprise a portion of the point of sale register 280. To initiate a query 40 using the point of sale device 38, an identification of the consumer 28 first must be made, shown at reference 282 of FIG. 9. The identification of the consumer 28 may be accomplished using a credit card reader, a rewards card, a telephone number, or any other customer specific database maintained by the point of sale merchant, such as a rewards or membership program. The query 40 includes transaction information 284 concerning the proposed transaction between the consumer 28 and the point of sale merchant. Additionally, the query 40 includes any information provided by the point of sale merchant as a customized consumer profile 170, as described above with reference to FIG. 6. The query 40 is received by a processor 286 resident in the point of sale device 38. The processor 286 may have direct access to the master database 24, or may send the query 40 over the Internet 18 to the central computer 16 to access the master database 14.

Upon submission of the query 40, including any customized profile information 170, the processor 286 either directly evaluates the query 40 against the master database 24 stored locally on the point of sale device 38, or sends the processor 286 sends the query 40 off to the central computer 16 for evaluation against the master database 24. If the processor 286 sends the query 40 to the central computer 16, then the central computer 16 generates the binary response 46 that comprises only one of an approval and a disapproval for the commercial transaction 26, or for the at least one consumer 28 that is the subject of the query 40, as described above. If the processor 286 directly evaluates the query 40 against the master database 24, the processor 286 generates the binary response 46 that comprises only one of an approval and a disapproval for the commercial transaction 26, or for the at least one consumer 28 that is the subject of the query 40. Thus, the point of sale device 38 may be configured to locally perform the query evaluation functions of the central computer 16. The only one of an approval and a disapproval may be displayed in any conventional manner, for example, as a red or green light, as a notice on the register 280, as a notice displayed on the point of sale device 38, and the like.

Additionally, each access to the point of sale device 38 will also generate additional payment pattern information 26 associated with one or more consumer 28 that may be temporarily stored on the point of sale device 38. The point of sale device 38 may also be configured to update the master database 24, including one or more searchable databases, maintained on the central computer 16 either continuously or from time to time via a network and/or the Internet, and may further be configured to have the master database 24 transmitted for local storage and access on the point of sale device 38 from time-to-time to ensure that the master database 24 is up to date and current.

Returning to FIG. 8, it is foreseeable that certain consumers 28 and certain first users 14 or third parties 230, 232, 234, 236, 238 may be reluctant to share payment pattern information 26 of their respective consumers 28. Alternatively, it is desirable to provide a method to automatically validate and determine a quality of payment pattern information 26 submitted by the first users 14 or by the third parties 230, 232, 234, 236, 238, and to encourage the first users 14 and the third parties 230, 232, 234, 236, 238 to continually update the payment pattern information 26 submitted to the master database 24. In one embodiment of the disclosure, shown in FIG. 8, the central processing computer 16 includes a usage tracker 264 that tracks access to payment pattern information 26 associated with a specific consumer 28, and further tracks the first user 14 from which the accessed payment pattern information 26 originated. Based on data compiled by the usage tracker 264, a reward, indicated by reference 270 in FIG. 8, is periodically paid to one or more of the first users 14 or third parties 230, 232, 234, 236, 238. In one embodiment, the reward 270 paid to the one or more of the first users 14 or third parties 230, 232, 234, 236, 238 is based at least in part on a frequency of queries 40 made to access the payment pattern information 26 of the at least one first consumer 28 submitted by the one or more of the first users 14 or third parties 230, 232, 234, 236, 238. The reward 270 may be arbitrary, or it may be based on any metric related to receipt of the queries 40, including, as a non-limiting example, limiting the queries 40 by SIC code. In one embodiment, the reward 270 includes a fixed amount for each access to the master database 40 associated with a particular first consumer 28. In another embodiment, the reward 270 may be based on a percentage of revenue generated through receipt of the queries within a particular industry descriptor, such as SIC code. The reward 270 therefore serves to incentivize the one or more of the first users 14 or third parties 230, 232, 234, 236, 238 to connect to the central computer 16 and to submit payment pattern information 26 of at least one first consumer 28. The reward 270 further incentivizes continual updating of the master database 24. Over time, the master database 24 may include a significant amount of payment pattern information 26 representative of the Unreported Debt economy, and will be able to track the Unreported Debt economy in a way that no currently existing conventional modern debt reporting tool is capable. For example, information generated in one industry, either classified by SIC Code or by any other metric, may become available to other industries because the system and method of the present disclosure is able to process information gathered by many different clearing houses efficiently to provide it to other industries or to providers of goods and services. Accordingly, the present system and method provides an open forum crowd sourced method for tracking payment pattern information of potential consumers that may be limited by SIC/NAICS code when desired. For example, the centralized computer can assign a unique code to identify a business segment, similar to a SIC/NAICS code, to a consumer where the consumer does not have a pre-existing SIC/NAICS code.

From the foregoing description, one ordinarily skilled in the art can easily ascertain the essential characteristics of this disclosure and, without departing from the spirit and scope thereof, make various changes and modifications to the disclosure to adapt it to various usages and conditions.

What is claimed is:

1. A computer method of pre-qualifying and warning business owners of customer risk, the method involving a system having a central computer in communication with a first computer device of a first user by the Internet, the central computer including a server having a processor and a memory, the method comprising the steps of:
sending by the first computer device of the first user to the central computer payment pattern information of at least one first consumer;
storing by the central computer the payment pattern information received from the first computer device;
creating a searchable database including the payment pattern information of the at least one first consumer received from the first computer device;
receiving a query from a second computer device of a second user;
comparing the query to the payment pattern information of the at least one first consumer in the searchable database;
generating one of only an approval and a disapproval in response to the query; and
transmitting the one of only an approval and a disapproval to the second computer device of the second user.

2. The method of claim 1, further including the steps of:
tracking of each query of payment pattern information of the at least one first consumer in the searchable database; and
disbursing a payment to the first user based at least in part on a frequency of the query to the payment pattern information of the at least one first consumer sent by the first computer device of the first user to the central computer.

3. The method of claim 1, wherein the payment pattern information is in the form of one of a text message, an email, a web application, and a database transfer application.

4. The method of claim 1, wherein the searchable database is resident on the second computing device.

5. The method of claim 4, wherein the second computing device is a point of sale device.

6. The method of claim 1, wherein the one of only the approval and the disapproval is displayed on the second computer device of the second user.

7. The method of claim 1, wherein the query is limited by a SIC/NAICS code.

8. The method of claim 1, wherein the query includes customized consumer profile criteria against which to evaluate the payment pattern information of the at least one consumer contained in the searchable database.

9. The method of claim 8, wherein the one of only an approval and a disapproval is based at least in part on an identity of the at least one first consumer and the customized consumer profile criteria.

10. A computer method of pre-qualifying and warning business owners of customer risk, the method involving a system having a central computer in communication with a first plurality of computer devices operated by a second plurality of information sources, the central computer in communication with the first plurality of computer devices by the Internet, the central computer including a server having a processor and a memory, the method comprising the steps of:
receiving by the central computer payment pattern information of a third plurality of consumers from one or more of the first plurality of computer devices operated by the second plurality of information sources, wherein the payment pattern information of the third plurality of consumers is in the faith of one of a text message, an email, a web application, and a database transfer application;
storing by the central computer the payment pattern information of the third plurality of consumers received from the one or more of the first plurality of computer devices operated by the second plurality of information sources;
creating a searchable database including the payment pattern information of the third plurality of consumers received from the one or more of the first plurality of computer devices operated by the second plurality of information sources;
receiving a query from a second computer device of a second user, the second user contemplating commercial activity with one or more of the third plurality of consumers;
comparing the query to the payment pattern information of the one or more of the third plurality of consumers;
generating one of only an approval and a disapproval in response to the query; and
transmitting the one of only an approval and a disapproval to the second computer device of the second user.

11. The method of claim 10, further comprising the steps of:
tracking of each query of payment pattern information for each of the third plurality of consumers and of the origin of the payment pattern information among the one or more of the first plurality of computer devices and the second plurality of information sources; and
disbursing a payment to the one or more of the second plurality of information sources based at least in part on a frequency of queries to the payment pattern information provided by the one or more of the second plurality of information sources received by to the central computer.

12. The method of claim 10, wherein the payment pattern information of the third plurality of consumers includes identification information of the third plurality of consumers.

13. The method of claim 10, wherein the searchable database is resident on the second computing device.

14. The method of claim 13, wherein the second computing device is a point of sale device.

15. The method of claim 10, wherein the one of only an approval and a disapproval is displayed on the second computer device of the second user.

16. The method of claim 15, wherein the query is limited by SIC/NAICS code.

17. The method of claim 10, wherein the query includes customized consumer profile criteria established by the second user, and wherein the one of only an approval and a disapproval is based at least in part on an identity of the one or more of the third plurality of consumers and the customized consumer profile criteria.

18. A computer method of pre-qualifying and warning business owners of consumer risk, the method involving a system having a central computer in communication with a first computer device of a first user, the central computer in communication with the first computer device of the first user by the Internet, the central computer including a server having a processor and a memory, the method comprising the steps of:
sending by the first computer device of the first user to the central computer payment pattern information of at least one first consumer;
storing by the central computer the payment pattern information received from the first computer device;
creating a searchable database including the payment pattern information of the at least one first consumer received from the first computer device;
transmitting the searchable database to a point of sale device;
querying the modified searchable database on a point of sale device by a second user to obtain the payment pattern information of the at least one first consumer from the searchable database, the query including customized profile criteria established by the second user;
generating one of only an approval and a disapproval in response to the querying step, the one of only an approval and a disapproval based at least in part on an identity of the at least one first consumer and the customized profile criteria; and
providing the second user with the one of only an approval and a disapproval and displaying the one of only an approval and a disapproval on the second computer device of the second user.

19. The method of claim 18, further including the steps of:
tracking of each querying step of payment pattern information of the at least one first consumer in the searchable database; and
disbursing a payment to the first user based at least in part on a frequency of querying the payment pattern information of the at least one first consumer sent by the first computer device of the first user to the central computer.

20. The method of claim 18, wherein the step of generating one of only an approval and a disapproval in response to the querying step further comprises the steps of:
detemining whether the at least one first consumer is identified;
determining whether the at least one first consumer is one of verified and trusted;
evaluating the at least one first consumer to determine if the at least one first consumer meets one of established qualification and established disqualification aspects for the query, the one of established qualification and established disqualification aspects based at least in part on the customized profile criteria;
generating the approval if the at least one first consumer is identified and at least one of verified, trusted, meets established qualification aspects and does not meet established disqualification aspects; and
generating the disapproval if the at least one first consumer is at least one of not identified, not verified, not trusted, does not meet established qualification aspects, and meets established disqualification aspects.
